(19) United States
(12) Patent Application Publication
(10) Pub. No.: US 2006/0114911 A1
(43) Pub. Date: Jun. 1, 2006

(54) Collection and analysis of route data for "Forward and Reverse" routes

(75) Inventor: Mark V. Nguyen, Fremont, CA (US)

Correspondence Address: MICHAEL B. EINSCHLAG, ESQ., 25680 FERNHILL DRIVE, LOS ALTOS HILLS, CA, 94024, US

(73) Assignee: Applied Expert Systems, Inc., Menlo Park, CA (US)

(21) Appl. No.: 11/266,009

(22) Filed: Nov. 3, 2005

Related U.S. Application Data
(60) Provisional application No. 60/624,671, filed on Nov. 3, 2004.

(51) Int. Cl. H04L 12/56

(52) U.S. Cl. 370/395.4

(57) ABSTRACT

One embodiment of the present invention is a method for collecting route data for forward and reverse routes that includes: (a) scheduling route data collection for a forward route; and (b) scheduling route data collection for a reverse route; wherein the scheduling for the forward and reverse routes provides for data collection to be initiated at about the same time.

This application relates to U.S. Provisional Application No. 60/624,671 filed Nov. 3, 2004, from which priority is claimed under 35 USC §119(e), and which is incorporated herein in its entirety.

### TECHNICAL FIELD OF THE INVENTION

One or more embodiments of the present invention relate generally to collecting and analyzing route data, simultaneously or otherwise, from both end points of a route to enable route comparisons for two points on a network such as, for example and without limitation, the dynamic Internet.

### BACKGROUND OF THE INVENTION

Enterprise TCP/IP networks are characterized by users who span the globe and require consistent, efficient access to mission-critical applications. TCP/IP networks fit the demands of mission-critical applications because of their ability to provide continuous service with little or no downtime. This is provided by dynamic routing and an ability to add hosts without centralized control. However, these strengths of TCP/IP networks also make them difficult to manage in terms of problem diagnosis, performance tuning, and capacity planning (for example, a path connecting one network node to another network node can change dynamically from time to time, depending on multiple factors that govern one network relative to another). For example, problems may appear to be caused by performance issues such as poor response time when the true cause is congestion or a route failure due to looping, packet loss, or an unreachable route. Without a mechanism for collecting and analyzing data in a systematic framework which, for example, enables one to review the performance of routes and segments over a period of time, resources can be misspent on unnecessary tuning or on acquiring expensive equipment that does not solve the real problem. As such, successful analysis of routing behavior in an enterprise TCP/IP environment requires centralized collection of volumes of data from multiple, and sometimes duplicate, routes and segments that span specific regions of the country and often the globe. Once this data is gathered there must be a system that organizes and analyzes it in such a way that makes it both easy to access and to understand.

In light of the above, there is a need for system and method to overcome one or more of the above-identified problems.

### SUMMARY OF THE INVENTION

One or more embodiments of the present invention are systems and methods that overcome one or more of the above-identified problems. In particular, one embodiment of the present invention is a method for collecting route data for forward and reverse routes that comprises: (a) scheduling route data collection for a forward route; and (b) scheduling route data collection for a reverse route; wherein the scheduling for the forward and reverse routes provides for data collection to be initiated at about the same time.

### BRIEF DESCRIPTION OF THE DRAWING

FIG. 1 shows Master-Agent relationships that are established in accordance with one or more embodiments of the present invention;

FIG. 2 shows examples of IP-addressable network nodes that may be accessed by various eCollector Agents, and examples of paths and segments of such paths that are monitored by these eCollector Agents in accordance with one or more embodiments of the present invention;

FIG. 3 shows an embodiment of the present invention used to collect route data for “Forward and Reverse” routes;

FIG. 4 shows a screen-shot for configuring end-points [137.72.43.30 to 137.72.43.59] of a forward route in accordance with one or more embodiments of the present invention;

FIG. 5 shows a screen-shot for setting TRACERT parameters for forward route data collection in accordance with one or more embodiments of the present invention;

FIG. 6 shows a screen-shot illustrating that route data collection is sent back to, and reported by, a Master module in accordance with one or more embodiments of the present invention;

FIG. 7 shows a screen-shot for configuring end-points [137.72.43.59 to 137.72.43.30] of a reverse route in accordance with one or more embodiments of the present invention;

FIG. 8 shows a screen-shot for setting TRACERT parameters for reverse route data collection in accordance with one or more embodiments of the present invention;

FIG. 9 shows a screen-shot illustrating that route data collection is sent back to, and reported by, the Master module in accordance with one or more embodiments of the present invention;

FIG. 10 shows a screen-shot illustrating that imported data for route data collection sessions are ready to be analyzed in accordance with one or more embodiments of the present invention;

FIG. 11 shows a screen-shot providing an analysis of a forward route from 137.72.43.59 to 137.72.43.30 consisting of one hop in accordance with one or more embodiments of the present invention;

FIG. 12 shows a screen-shot providing an analysis of a reverse route from 137.72.43.30 to 137.72.43.59 consisting of one reverse hop in accordance with one or more embodiments of the present invention;

FIG. 13 shows a screen-shot of a Route Analysis module indicating the various reports that are available in accordance with one or more embodiments of the present invention;

FIG. 14 shows a screen-shot of a “Route Performance Detail by Segments” report for forward and reverse routes in accordance with one or more embodiments of the present invention;

FIG. 15 shows a screen-shot of a “Data Summary Report by Segments” report for forward and reverse routes in accordance with one or more embodiments of the present invention;

FIG. 16 shows a screen-shot of a “Route(s) with Best Performance” report for forward and reverse routes in accordance with one or more embodiments of the present invention;

FIG. 17 shows a screen-shot of a “Route(s) with Worst Performance” report for forward and reverse routes in accordance with one or more embodiments of the present invention;

FIG. 18 shows a screen-shot of a “Segment(s) with Best Performance” report for forward and reverse routes in accordance with one or more embodiments of the present invention;

FIG. 19 shows a screen-shot of a “Segment(s) with Worst Performance” report for forward and reverse routes in accordance with one or more embodiments of the present invention; and

FIG. 20 shows a screen-shot of an “Aggregate Route Response Time Summary” report for forward and reverse routes in accordance with one or more embodiments of the present invention.

### DETAILED DESCRIPTION

One or more embodiments of the present invention are software applications for measuring, among other things, response times (including end-to-end response times) incurred while carrying out transactions on a network such as, for example, and without limitation, the world wide web, the Internet, an intranet, a local area network, a wide area network, combinations of these transmission media, equivalents of these transmission media, and so forth. It should be understood that further embodiments of the present invention may be fabricated for use with other types of networks, without limitation.

In particular, a CLEVER eRoute® software application is a distributed software application that is fabricated in accordance with one or more embodiments of the present invention that enables one actively to analyze TCP/IP network routes and segments, and to examine peaks and valleys of performance levels of such TCP/IP network routes and segments. As such, the CLEVER eRoute® software application can be used proactively to reduce faults and to improve response and transaction times in a network route by route and segment by segment. Specifically, the CLEVER eRoute® software application enables one to carry out a centralized, systematic analysis of route and segment data for use by network support personnel to pinpoint congested and defective routes, and to analyze usage patterns. Advantageously, the CLEVER eRoute® software application enables network planners, performance analysts, operations personnel, network system programmers, and capacity planners to monitor performance, troubleshoot network problems, and manage future growth effectively. For example, capacity planners can better balance workload by changing “neighbor” assignments, path priorities, or even redeploying existing network hardware, rather than purchasing additional equipment.

In accordance with one or more embodiments of the present invention, the CLEVER eRoute® software application is based on a client-server communication model referred to as Agent-Master. As such, a Master module is set up in a network so that the Master module is a command center of operations. In accordance with one or more embodiments of the present invention, the CLEVER eRoute® software application runs, for example, and without limitation, independently on a PC Workstation platform that supports Windows NT w/SP6, Windows 98, Windows ME, Windows 2000, Windows XP, or Linux.

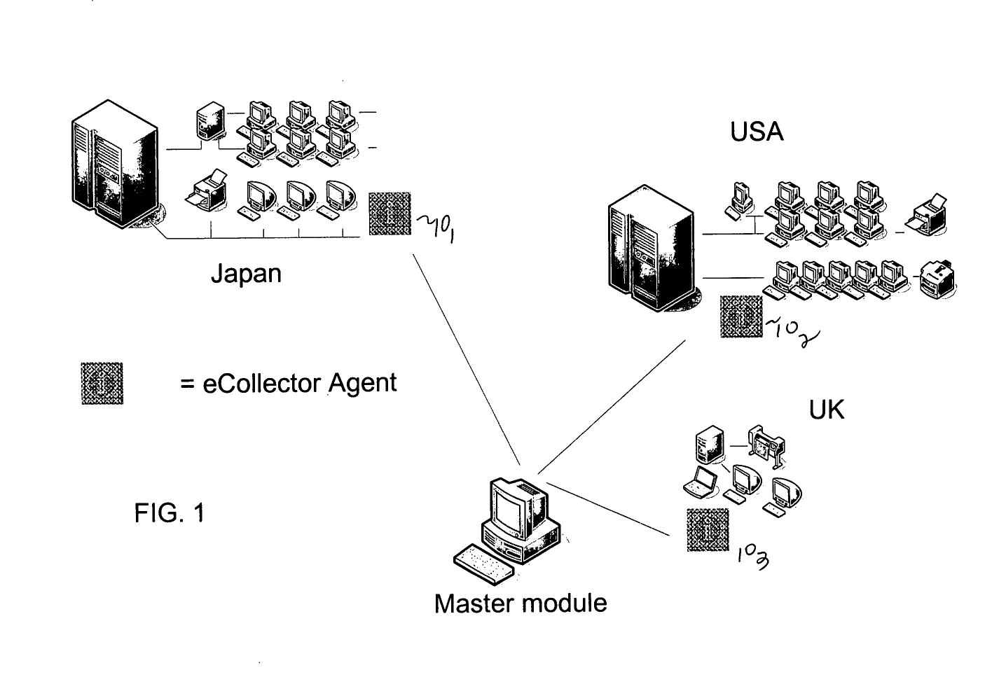

FIG. 1 shows Master-Agent relationships that are established in accordance with one or more embodiments of the present invention. In accordance with one or more embodiments of the present invention, the Master module is used to configure Agents, referred to as eCollector Agents, in a manner that will be described in detail below. In accordance with one or more embodiments of the present invention, and as shown in FIG. 1, eCollector Agents 10₁ to 10₃ are software applications that reside remotely from the Master module. Once installed and linked to the Master module in accordance with any one of a number of methods that are well known to those of ordinary skill in the art (eCollector Agents are installed on as many PC workstations as one deems necessary), activities carried out by the eCollector Agents are managed from the Master module by way of a client-server relationship.

In accordance with one or more embodiments of the present invention, Internet Control Message Protocol (ICMP) methods are used to probe a TCP/IP network for performance/problems. A standard for ICMP, an extension to the Internet Protocol (IP), is defined by RFC792. Information relating to RFC792 can be found at Internet Engineering Task Force (IETF)'s reference for RFC792: http://www.ietf.org and http://www.faqs.org/rfcs/rfc792.html. ICMP commands support packets containing error, control, and information messages. In particular, two ICMP commands, i.e., TRACERT and PING, have long been known as default utilities for major operating systems. Specifically, the TRACERT command uses ICMP to echo back response-time and node identification for each hop along a path from/to any two points on a network. As a result, the TRACERT command provides useful data for examining the response time for each hop on a path from a starting point to an end point; as well as identifying the path connecting the two points. PING uses timed IP/ICMP ECHO_REQUEST and ECHO_REPLY packets to probe a “distance” to a target machine. As is well known, it works by sending a data packet to a specified IP address and waiting for a reply. To diagnose a network node, typically, the PING command is used to detect the remote destination, and the TRACERT command is subsequently used to determine the path that an IP packet has taken to reach that remote destination. Information regarding TRACERT and PING may be found at: ICMP Trace-route: http://www.microsoft.com/resources/documentation/windows/xp/all/proddocs/enus/tracert.mspx; and ICMP Ping: http://ftp.arl.mil/˜mike/ping.html, respectively.

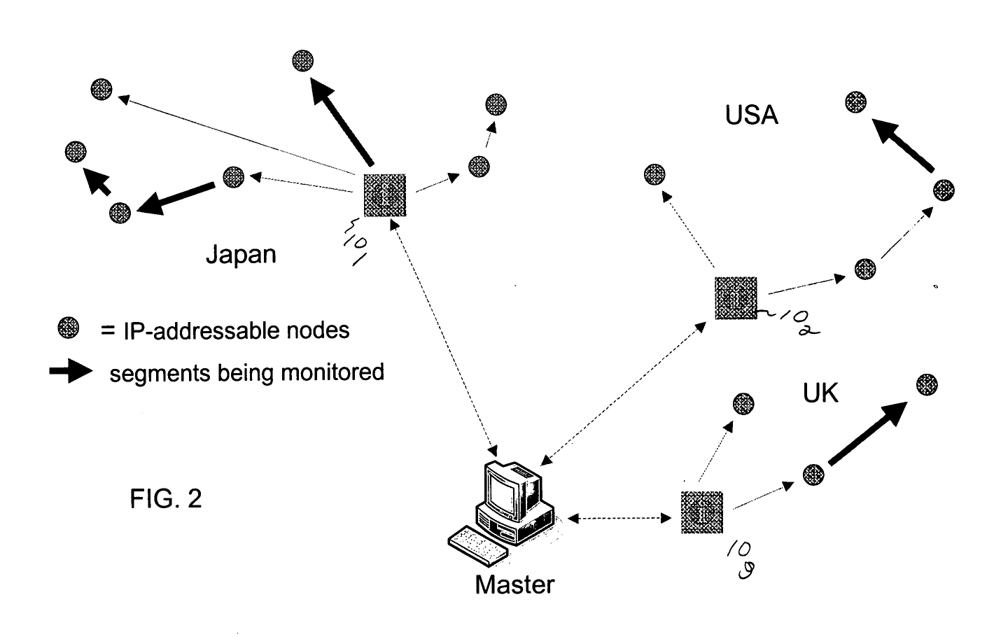

FIG. 2 shows examples of IP-addressable network nodes that may be accessed by eCollector Agents 10₁ to 10₃, and examples of paths and segments of such paths that are monitored by these eCollector Agents. In accordance with one or more embodiments of the present invention, the PING and TRACERT commands are utilized to collect data relating to the paths and the segments of the paths.

In accordance with one or more embodiments of the present invention, before an eCollector Agent collects data, a “Host-IP” file is created, where the Host-IP file contains a list of all endpoints for a trace (i.e., a data collection session). In accordance with one or more embodiments of the present invention, an endpoint may be, for example and without limitation, a router, a critical resource, a desktop, or an MVS TCP/IP host. In accordance with one or more embodiments of the present invention, the Host-IP file may be created by having the Master module send a command to an eCollector Agent to cause it to execute a routine to detect all valid IPs on the eCollector Agent's network (referred to as an Auto-Detection routine (to be described in detail below)). Alternatively, a user can create a “Host-IP” file by: (a) using a user interface routine at the Master module (the user interface may be implemented in accordance with any one of a number of methods that are well known to those of ordinary skill in the art) to create and/or update a file; and then (b) causing the Master module to transfer the Host-IP file to the eCollector Agent via the Internet. Once an eCollector Agent has a Host-IP file, it can carry out its data collection routine, and transfer the data back to the Master module for analysis. In particular, in accordance with one or more embodiments of the present invention, data collected by eCollector Agents is: (a) saved as a data (.DAT) file; (b) automatically written to a sub-directory named “Data”; and (c) sent to a Master module via file FTP. Then, it is imported and analyzed at the Master module.

Thus, in accordance with one or more embodiments of the present invention, the Master module obtains data from eCollector Agents (it should be noted that in accordance with one or more embodiments of the present invention, an eCollector Agent may be local to the machine at or on which the Master module is situated). In accordance with one or more embodiments of the present invention, eCollector Agents carry out data collection sessions by performing TRACERT commands from a starting point to a set of network nodes (a network node being any IP-addressable device) set forth in the Host-IP file. The TRACERT commands transmit packets to each node along a path that constitutes a route (i.e., a path between a Starting and Ending Point that may consist of one or more segments where a segment or hop is a path between two network nodes), and outputs a millisecond response time for each packet. A dominant route is the route used most frequently between a specific Starting and Ending Point. Each response time associated with each network node is collected and saved in an output file that provides raw data for the Master module to analyze. The output file from the eCollector Agents provide information on route performance, number of segments or hops, and each host detected along the route. Analysis routines of the Master module analyze the data by systematically organizing and presenting it to a user in various formats. As such, the CLEVER eRoute® software application collects enterprise-wide, end-to-end, route performance data remotely (at the local server, or even workstation, level) from the perspective of: routers; end-point users; application servers; host-centric mainframe routing; whether Wintel, Linux, and/or z/OS. Further, any number of eCollector Agents can be deployed throughout the network as needed, on Wintel or Linux PCs, Workstations, or Servers. Still further, data for round-trip or “Forward and Reverse” routes between user-determined end points can be collected at pre-defined intervals to provide an historical database of route performance and failure traffic patterns. In accordance with one or more embodiments of the present invention, the CLEVER eRoute® software application identifies usage patterns, congestion, and defects for capacity planning by providing analysis of end-points, routes, segments or hops, time ranges, and response criteria.

In accordance with one or more embodiments of the present invention, a Master module is installed, for example and without limitation, on a Wintel PC, Workstation or Server—the Master module can reside anywhere in a network. Further, any number of remote eCollector Agents can be installed throughout the network, on Wintel or Linux PCs, Workstations, or Servers (for example and without limitation, eCollector Agent software could be installed on multiple PCs at various points in the network)—note that the Master module controls all configured eCollector Agents concurrently. Then, for a particular eCollector Agent, the Master module can cause the eCollector Agent to carry out an Auto-Discovery routine to search network(s) and sub-networks to “discover” all available IP addresses (wherever they might be physically located that are accessible therefrom). In accordance with one or more embodiments of the present invention, the Auto-Discovery routine will perform an IP address search range for one subnet (or a portion of a subnet). As one can readily appreciate, such a routine may be carried out utilizing any algorithm for developing the IP address search range such as, for example and without limitation, starting at a particular address for example 137.72.43.00 and probing all addresses from 137.72.43.01 to 137.72.43.255. As one can readily appreciate, the eCollector Agent may send a PING command to see if an address is active. In addition, and in accordance with one or more embodiments of the present invention, the Master module may specify information to restrict the eCollector's Agent's scope of “discovery.” The eCollector Agent then records the discovered IP addresses in a Host-IP list. As discussed above, the IP addresses in the Host-IP list may serve as end-points for scheduled route monitoring by remote eCollector Agents, which schedules are obtained in response to user input at the Master module and sent to the eCollector Agents. In accordance with one or more embodiments of the present invention, eCollector Agents can be (de)activated dynamically from the Master module in accordance with any one of a number of methods that are well known to those of ordinary skill in the art. Further, in accordance with one or more embodiments of the present invention, remote eCollector Agents send out periodic broadcasts to identifying themselves. In response, the Master module acknowledges the remote eCollector Agents, and maintains ongoing “heartbeat” control sessions with them.

In accordance with one or more embodiments of the present invention, eCollector Agents may begin collecting trace route data between pre-defined end-points (set forth in the Host-IP file) on a scheduled basis. As illustrated in FIG. 2, the paths may pass through any number of IP-addressable network or sub-network nodes, and there might be multiple “hops” or IP addresses on the route between an eCollector Agent and the end-points it is accessing. In addition, during the “heartbeat” control sessions between the Master module and the eCollector Agents, the Master module may, at any time, request data collected by the eCollector Agents to be sent to the Master module for central analysis. Once the data are collected at the Master module, the user may choose intermediary end-points as subjects for examination, providing flexibility in route performance analysis.

In accordance with one or more embodiments of the present invention, eCollector Agents are constantly listening for commands from the Master module to perform route data collections (since the main purpose of an eCollector Agent is to perform a specified route data collection on a remote PC), and to send the resulting data back to the Master module. Further, in accordance with one or more such embodiments, since the eCollector Agents operate in Agent-Server Mode, meaning they run as a background service, the main function of the eCollector Agents is to service the Master module's commands as a background task.

In accordance with one or more embodiments of the present invention, route data can be collected in real-time (in response to a command received from the Master module) or via periodic or scheduled collections. As was described above, the Master module provides user control over all eCollector Agents that are configured to address the Master module. Each active eCollector Agent automatically broadcasts a status message to the Master module at predetermined intervals, for example and without limitation, 15-minute intervals. The Master module uses these repeated broadcast messages to build and maintain a list of available eCollector Agents, which list may be updated each time a broadcast message is received from a new eCollector Agent. The user may communicate directly with a specific eCollector Agent by selecting it from the list, and for example, commanding it to collect data from a specific path in the network.

Utilizing the CLEVER eRoute® software application, one can schedule data collection over multiple network routes automatically (in fact, using the CLEVER eRoute® software application, one can schedule multiple data collections between multiple end-points simultaneously). This is advantageous since manually initiating data collection routes is labor-intensive (it typically averages one minute to complete one data collection cycle for a single destination—and then the results still need to be analyzed). In addition, summary reports provided by the CLEVER eRoute® software application may identify all routes and segment hops as well as aggregate response times and/or defects. In further addition, fault reports point out suspected defect points, types, and number of occurrences in the routing samples being analyzed. This enables one to zoom-in quickly for additional analysis or comparisons in order to determine appropriate corrective actions.

As was described above, the Master module is used to cause Host-IP files to be created or to create Host-IP files using manual input. In addition, the Master module is used to configure route collection parameters by obtaining user input by means of user interfaces that may be fabricated utilizing any one of a number of methods that are well known to those of ordinary skill in the art. In addition, the Master module may command route data collection using either a “Quick Start” command which is relayed to a relevant eCollector Agent or by enabling a user to set Schedule Options. In addition, in accordance with one or more embodiments of the present invention, a user may view communications between the Master module and the eCollector Agents, check the status of any listed eCollector Agents, or PING eCollector Agents.

In accordance with one or more embodiments of the present invention, an eRoute module is an application wherein collected data is gathered together, analyzed, and formatted into graphical and/or tabular reports. Within this module are three “tabs” for user invocation. An Import tab is used to import data from route data collections into the eRoute module for analysis. An Analysis tab enables a user to select among a variety of analysis reports. In accordance with one or more embodiments of the present invention, the CLEVER eRoute® software application provides both graphical and tabular displays of the route data collected. The graphical format (otherwise referred to as charts) provide information on: (a) Failures by Type (packet loss, looping or failing) as seen per route, segment, or time, including Time of Day reports to detect highs and lows (Peaks & Valleys); (b) Performance analysis per segment or route by tracking the response time distribution over a selected time period, including Time of Day reports to detect highs and lows (Peaks & Valleys); and (c) Workload or patterns of usage for the network's most shared segments and routes, including Time of Day reports to detect highs and lows (Peaks & Valleys). For example and without limitation, reports are variously provided as: “Most Failing Route(s)”; “Most Failing Segment(s)”; “Failure(s) by Time of Day”; “Most Packet-Losing Route(s)”; “Most Packet-Losing Segment(s)”; “Packet Losses by Time of Day”; “Most Looping Routes”; “Most Looping Segments”; “Looping(s) by Time of Day”; “Route(s) with Best Performance”; “Segment(s) with Best Performance”; “Route(s) with Worst Performance”; “Segment(s) with Worst Performance”; “Route Performance Distribution”; “Segment Performance Distribution”; “Performance by Time of Day”; “Most Dominant Route(s)”; “Most Shared Host(s)”; and “Most Shared Segment(s).” In addition, one can view a “Route Detail by Segments Report”. One can also view tabular Summary Reports: “Data Summary Report by Routes”; “Data Summary Report by Segments”; “Summary Report of Defective Routes”; and “Summary Report of Defective Segments.”

Thus, as has been described above, in accordance with one or more embodiments of the present invention, a Master module is used to control eCollector Agents in response to inputs received from a user utilizing a GUI that may be fabricated utilizing any one of a number of methods that are well known to those of ordinary skill in the art. In particular, using a “Setup” tab enables a user to do any of the following: (a) select an eCollector Agent from a list, and if there is one, (i) create a Host-IP file on the eCollector Agent using an “Auto-Discover Host-IP file” option, (ii) create a Host-IP file on the remote eCollector Agent using an “Edit Host-IP file” option, or (iii) adjust route collection parameters using a “Configure Route Collection” option. For example and without limitation, to create a Host-IP file on an eCollector Agent using the Auto-Discover Host-IP file option, one may select an eCollector Agent, and input information relevant to that eCollector Agent such as: (i) Field Name; (ii) Subnet; (iii) IP address for the selected eCollector Agent's subnet; (iv) lower limit for the subnet address range (for example, a default may be 1); and (v) upper limit for the subnet address range (for example, a default may be 255).

Using a “Start” tab enables a user to cause route data collection using either a “Quick Start” option or a “Schedule” option. The Quick Start option performs route data collection once on a selected eCollector Agent. The Schedule option enables the user to automate the route data collection process, and to schedule it to run on a regular basis according to the user's needs.

Using a “Status” tab enables a user to view communications between the Master module and the eCollector Agents, to check the status of any listed eCollector Agents, and to PING an eCollector Agent to determine whether that eCollector Agent is active.

In addition, in accordance with one or more embodiments of the present invention, a CLEVER eRoute® software application FTP Server is a stand-alone module that enables file transfers between eCollector Agents and the PC on which the Master module is running. In accordance with one or more such embodiments, the FTP server is invoked each time the Master module exits, so that it acts as a receiver of data in the absence of the Master module. This enables remote eCollector Agents to report data resulting from scheduled collections even if the Master module is not running. Whenever the Master module is next invoked, the CLEVER eRoute® software application FTP Server self-terminates, and relinquishes control of the receiving port back to the Master module. FTP authentication between the application's client component and the FTP server is automated in accordance with any one of a number of methods that are well known to those of ordinary skill in the art, and file transmissions are enabled only through proper authentication known internally to only the eCollector Agents and the CLEVER eRoute® software application FTP Server. The information (such as specific port ids) necessary to access the CLEVER eRoute® software application FTP Server and establish a connection is built into each eCollector Agent.

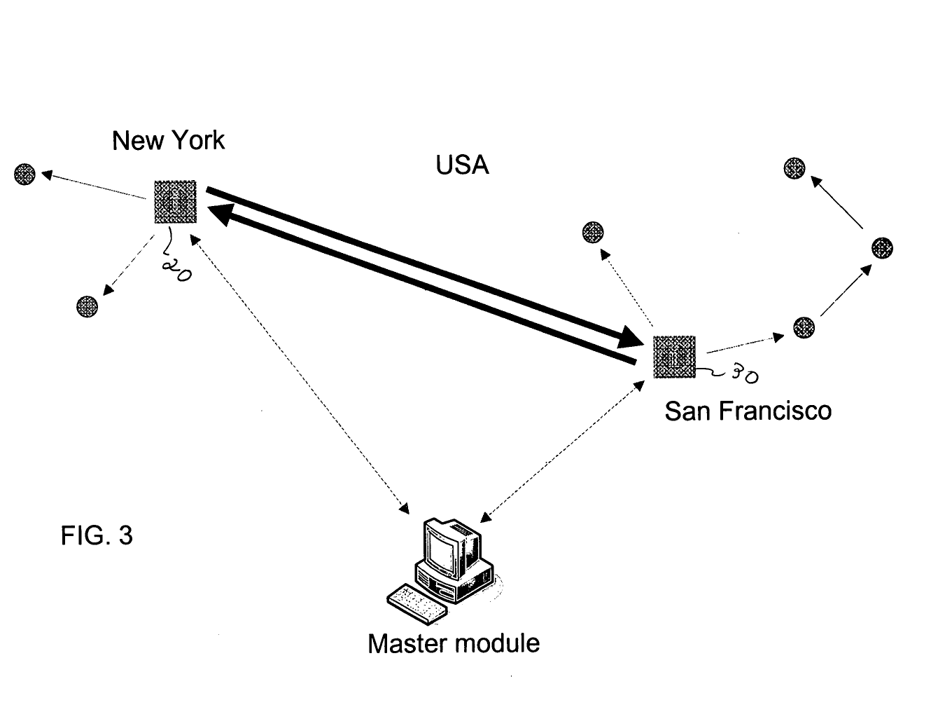

In accordance with one or more embodiments of the present invention, each eCollector Agent can collect data independently, and in multiple outbound and/or inbound directions, simultaneously. FIG. 3 shows an embodiment of the present invention used to collect route data for “Forward and Reverse” routes. Assume for example that there is a suspected performance problem on a route between New York and San Francisco in the USA network. From the Master module, a user (for example, a network administrator) can instruct eCollector Agent 20 in New York to “trace” activity (by executing the PING and TRACERT commands described above) between it (i.e., eCollector Agent 20 in New York) and San Francisco (for example, eCollector Agent 30 in San Francisco), i.e., the “Forward” direction. The user can also instruct eCollector Agent 30 in San Francisco to simultaneously “trace” activity between it (i.e., eCollector Agent 30 in San Francisco) and New York (for example, eCollector Agent 20 in New York), i.e., in the opposite or “Reverse” direction. Advantageously, and in accordance with one or more embodiments of the present invention, the resulting data may be used to pinpoint the source and nature of the problem. In particular, a “trace” entails performing a predetermined number of data transmissions so that trace-route data typically provides a minimum, a maximum, and an average response time. By viewing data collected for both directions, a comparison (for example and without limitation, of each hop) may indicate (for example and without limitation, where a bottleneck exists. As one can readily appreciate from this, such data collection may be carried out in response to a real-time command or on a scheduled basis at any or a multiplicity of times during the day. Advantageously, in accordance with one or more embodiments of the present invention, such data collection would be initiated at the same time, or at about the same time (for example and without limitation, within a time interval that is small to a desired amount), or within a predetermined interval of time.

As has been described above, the CLEVER eRoute® software application includes a network comprised of a multiplicity of components: a Master module and a multiplicity of eCollector Agents. For example, in accordance with one or more embodiments of the present invention, a Master module is a centralized component that controls remote execution of commands such as, for example and without limitation, PING and TRACERT. This functionality may be realized by implementing a TCP/IP Client/Server framework enabling asynchronous, full-duplex connection between local and remote ports. For example, and in accordance with one or more embodiments of the present invention, both the Master module and eCollector Agents have two reserved application ports dedicated to service a pre-defined set of command-codes: TCP port xl, and FTP port yl.

In accordance with one or more embodiments of the present invention, an eCollector Agent is a distributable module that also has a TCP/IP framework that mirrors the Master module's TCP/IP Client/Server framework. The difference is in how it logically treats TCP I/O messages. In particular, and in accordance with one or more embodiments of the present invention, all messages received by an eCollector Agent are treated as requests from the Master module that warrant service replies.

The following describes common components in a Master module and an eCollector Agent. In accordance with one or more embodiments of the present invention,

(a) a TCP port services a pre-defined set of command-codes exclusively shared between the Master module and its eCollector Agents; (b) sent data is encrypted in Stream I/O format; and (c) received data is decrypted and authenticated for valid product-code, command-code, and checksum. In accordance with one or more embodiments of the present invention, (a) an FTP port services a limited set of command-codes rather than the full set of File Transfer Protocol's command-codes; (b) encrypted logon information is validated before a connection is established; and (c) once a logon session is established, a timeout is set; specified action event will terminate at the timeout interval. In addition, both ports (TCP and FTP) are capable of handling multiple, asynchronous connections; and an authentication methodology is implemented for exclusive use for CLEVER eRoute® software application Master-Agent intercommunications.

TCP Port Functionality Operates as Follows:

a. Initialization: the TCP Port is initialized at program start-up in listening mode; and incoming connection requests are allowed for establishment only after valid authentication—invalid requests are dropped.

b. TCP Stream I/O: all TCP messages contain a header about source and destination plus information for authentication—invalid header information is considered to be a foreign message and, as such, is dropped. A valid message contains an enumerated action-request-event within its message body.

c. Action-request-event: valid requests from TCP I/Os are serviced by the receiving application (Master module or eCollector Agent). Depending on the specific event, a reply might be required—in such a case, results are packaged into a reply message and sent to the caller via a new TCP connection.

The following describes enumerated action-request-events enabling task requests from the Master module and service replies from the eCollector Agents:

Broadcast-from-Agent—a TCP message sent by an eCollector Agent to periodically broadcast its status to the Master module.

Broadcast-from-Master—a TCP message sent by the Master module to broadcast changes to its local connection information. Upon receiving, eCollector Agents re-build their connection header to reflect changes to subsequent connections. Generally, the Master module's broadcast message informs of changes to its IP address or DNS name.

Run-time Status—a TCP message sent by the Master module to solicit current status from an eCollector Agent. Current status comes in the form of “Percentage of task completion,” or a text message of the previous completed task.

Configure—a TCP message sent used by the Master module to send configuration parameters to an eCollector Agent. Upon receiving, configuration parameters are saved into a local initialization file. A reply message is required.

Schedule—a TCP message sent by the Master module to send scheduling tasks to an eCollector Agent. Upon receiving, scheduling parameters are saved into a local initialization file. A scheduler on the receiving end gets invoked as a system service process, and a TCP reply message containing the status is sent back to the Master module.

Discover—a TCP message sent by the Master module to direct an eCollector Agent to perform local network discovery. Upon receiving, parameters are applied, and a PING command is invoked to systematically scan for available network nodes. A discovered list of network nodes is saved, a copy is sent back to the Master module via an FTP connection, and a TCP reply message containing the status is sent back to the Master module.

Collect—a TCP message sent by the Master module to direct a route data collection execution session on a remote eCollector Agent. Upon receiving, trace parameters are applied, and a TRACERT command is invoked to trace against a Host-List IP file containing end-points. The collected data is saved, a copy is sent to the Master module via an FTP connection, and a TCP reply message containing the status is sent back to the Master module.

Toggle Log—a TCP message sent by the Master module to enable/disable logging on eCollector Agents.

Get-File-By-Name—a TCP message used by the Master module to retrieve a specific file from an eCollector Agent. Upon receiving, the FTP Server sends the requested file to the Client via an FTP connection.

Put-File—a TCP message sent by both to deposit requested file onto the remote end.

FTP Port Functionality Operates as Follows:

Initialization—an FTP port is initialized at program start-up. Successful connections must go through an automated, background logon process. Logon authentication must go through a decryption/validation process. Invalid logon and anonymous logon are dropped.

Action-request-events—Valid requests from the Client are serviced by the Server's end. There are cases where a TCP reply message is required after the completion of event.

The following describes enumerated action-request-events enabling task requests from the Master module and service replies from eCollector Agents:

PUT—Write a requested file to a specified remote location. Logoff, then send a TCP reply message to the caller.

RETR—Retrieve a requested file from a specified remote location. Logoff, then send a TCP reply message to the caller.

ABORT—Abort current event. Logoff, then send a TCP reply message to the caller.

Building a Master Module:

The Master module is built as a Graphical User Interface (GUI) application. The TCP port is programmed in multi-threaded mode to handle multiple asynchronous connections; likewise for the FTP port. Compilation definitions are used in the common code to differentiate the Master module from an eCollector Agent.

Sent TCP messages bear a Master module designation in their header. Expected reply messages should bear an eCollector Agent designation in the header. Incoming TCP messages are treated as replies or notifications. FTP operation is automated; an in-direct user interface is provided for PUT, RETR, and ABORT events through the enumerated TCP action-request-events.

Building an eCollector Agent:

An eCollector Agent is built as a background process application with notify icon showing at run-time. Compilation definitions are used in the common code to differentiate an eCollector Agent from the Master module. Incoming TCP messages are treated as requests. Outgoing TCP messages are formatted as reply messages. Since this program runs as a background process, all operations are automated, and no direct user interface is provided.

Scheduler:

A stand-alone scheduler's executable takes as an argument, a path to its initialization file. The initialization file contains dates and times and a list of end-points. The scheduler parses the initialization file for configuration parameters and invokes itself as a system service process. The scheduler's main purpose is to invoke the TRACERT command against a pre-defined list of end-points exactly at a scheduled date and time. Upon completion of the TRACERT command, data is saved and sent to the Master module via an FTP connection. The advantage of using the Scheduler is to simultaneously synchronize multiple collections from various eCollector Agents by scheduling each eCollector Agent to collect data at the same time.

Steps to Collect Route Data for “Forward” and “Reverse” Routes

Assume that two network nodes are defined by the following addresses: 192.168.101.12 and 198.93.144.3. Further assume that a “forward” route is defined as a route from node address 192.168.101.12 to node address 198.93.144.3 and that a “reverse” route is defined as a route from node address 198.93.144.3 to node address 192.168.101.12. Further assume that an eCollector Agent at node address 192.168.101.12 executes a TRACERT command targeting node address 198.93.144.3. In that case, the resulting data would provide information relating to the forward route. Further assume that another eCollector Agent at node address 198.93.144.3 executes a TRACERT command targeting node address 192.168.101.12. In that case, the resulting data would provide information relating to the reverse route. Subsequently, the two sets of data can be compared and analyzed relative to one another for response-times (i.e. Performance), patterns of deviations, or failures. Further, repeated collection of the same configuration over time would yield multiple snapshots useful for trend analysis.

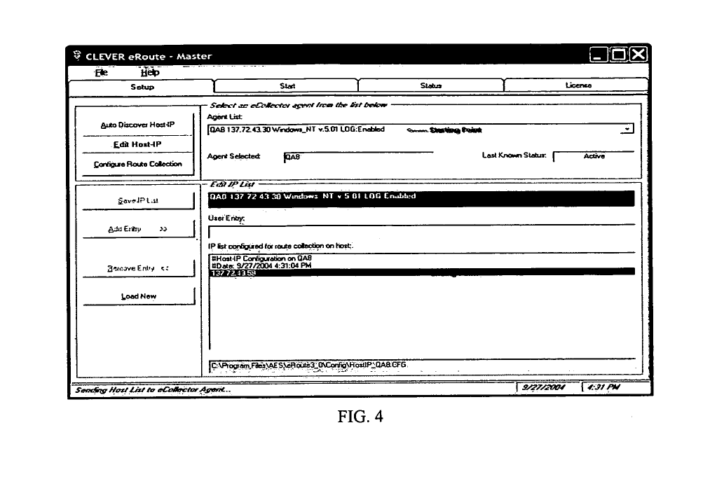

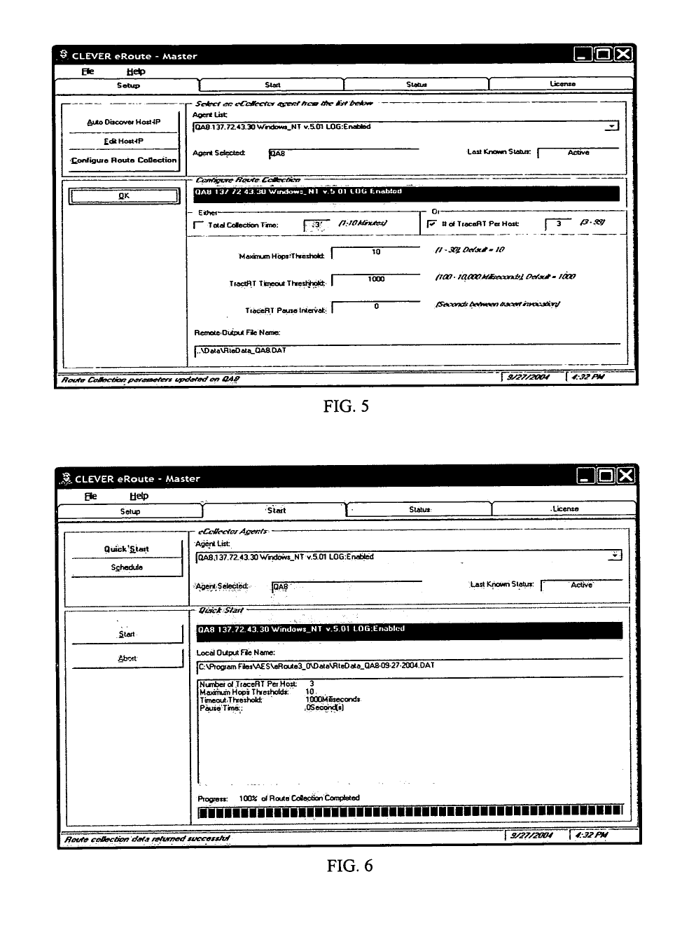

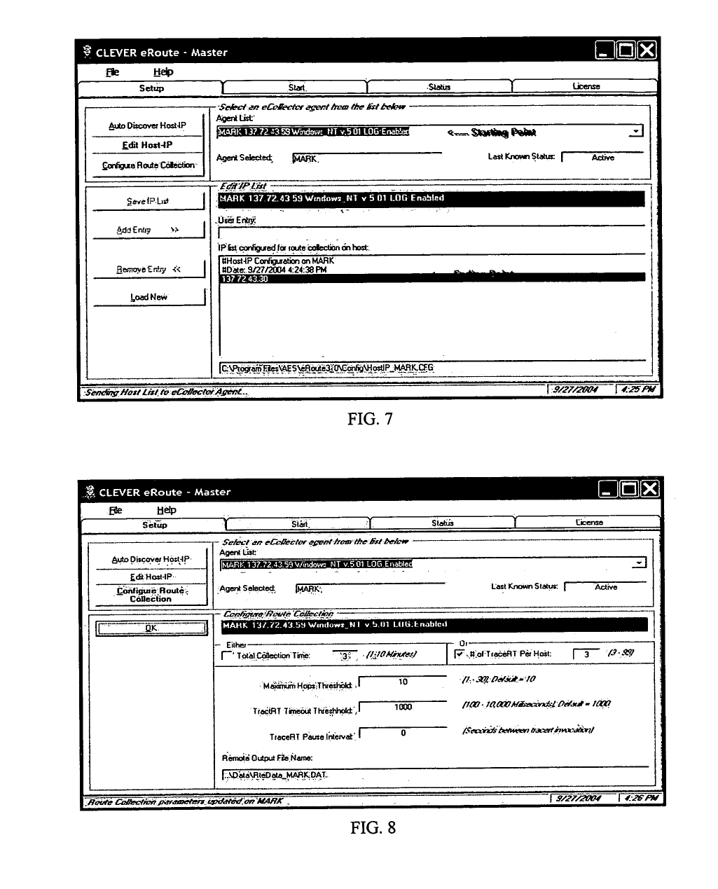

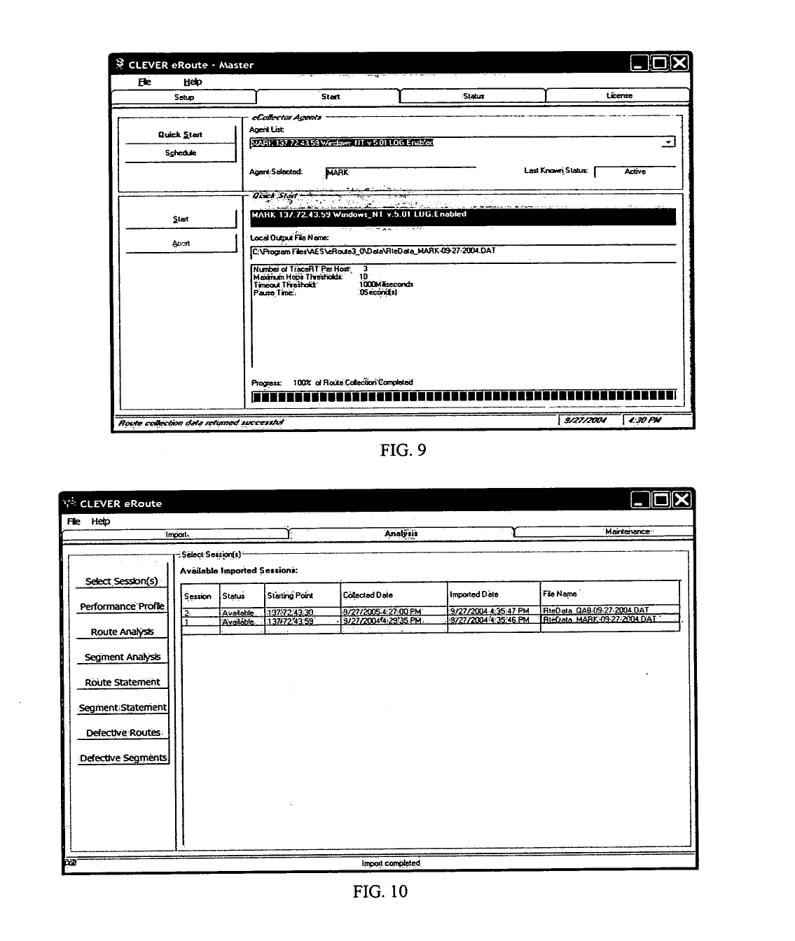

a. Collect Remote Data from a Master module. Using the Master module, one can remotely configure eCollector Agents and issue route data collection by following the following steps.
a. configure Forward End-point: (for example, any address from 137.72.43.30 to 137.72.43.59)
   select an address (for example, address 137.72.43.30) from a drop-down “Agent List” as a starting point
   add an address (for example, address 137.72.43.59) into an “IP Host-List” as an ending point
   click on a “Save IP List” button to send the settings to a remote eCollector Agent (for example, an eCollector Agent named QA8)—see FIG. 4 which shows a screen-shot for configuring end-points [137.72.43.30 to 137.72.43.59] of a forward route in accordance with one or more embodiments of the present invention, which screen-shot may be fabricated utilizing any one of a number of methods that are well known to those of ordinary skill in the art
b. set TRACERT parameters on the remote eCollector Agent: (137.72.43.30)
   click on the “Configure Route Collection” button and then click “OK” (the default TRACERT parameter settings would be sent to the remote eCollector Agent)—see FIG. 5 which shows a screen-shot for setting TRACERT parameters for a forward route data collection in accordance with one or more embodiments of the present invention, which screen-shot may be fabricated utilizing any one of a number of methods that are well known to those of ordinary skill in the art
c. collect Forward Trace-route Data
   select the “Start” tab and click on “Quick Start” (a TCP message containing an Action-Request-Event=Collect is sent to the selected eCollector Agent)
   real-time progress updates are continuously sent back and displayed as progress indicators
   upon completion, the Master module receives a file named C:\Program Files\AES\eRoute3_{—}0\Data\RteData_QA8-09-27-2004.DAT—see FIG. 6 which shows a screen-shot illustrating that route data collection is sent back to and reported by a Master module in accordance with one or more embodiments of the present invention, which screen-shot may be fabricated utilizing any one of a number of methods that are well known to those of ordinary skill in the art
d. configure Reverse End-point: (for example, any address from 137.72.43.59 to 137.72.43.30)
   select an address (for example, address 137.72.43.59) from a drop-down “Agent List” as the starting point
   add an address (for example, address 137.72.43.30) into the “IP Host-List” as an ending point
   click on the “Save IP List” button to send the settings to a remote eCollector Agent (for example, an eCollector Agent named MARK)—see FIG. 7 which shows a screen-shot for configuring end-points [137.72.43.59 to 137.72.43.30] of a reverse route in accordance with one or more embodiments of the present invention, which screen-shot may be fabricated utilizing any one of a number of methods that are well known to those of ordinary skill in the art
e. set TRACERT Parameters on the remote eCollector Agent (137.72.43.59)
   set TRACERT Parameter values exactly to those set in the Forward session—see FIG. 8 which shows a screen-shot for setting TRACERT parameters for a reverse route data collection in accordance with one or more embodiments of the present invention, which screen-shot may be fabricated utilizing any one of a number of methods that are well known to those of ordinary skill in the art
f. collect Reverse Trace-route Data:
   select the “Start” tab and click on “Quick Start” (a TCP message containing an Action-Request-Event=Collect is sent to the selected eCollector Agent
   real-time progress updates are continuously sent back and displayed as progress indicator
   upon completion, the Master module receives a file named “C:\Program Files\AES\eRoutes3_{—}0\Data\RteData_MARK-09-27-2004.DAT”—see FIG. 9 which shows a screen-shot illustrating that route data collection is sent back to and reported by a Master module in accordance with one or more embodiments of the present invention, which screen-shot may be fabricated utilizing any one of a number of methods that are well known to those of ordinary skill in the art

b. Import Data Files:

Upon completion of the above steps, the Master module has received two data files: “C:\Program Files\AES\eRoute3_{—}0\Data\RteData_QA8-09-27-2004.DAT” and “C:\Program Files\AES\eRoute3_{—}0\Data\RteData_MARK-09-27-2004.DAT”. Using an Import & Analysis module, the files can be imported into the database as aggregate data to be further analyzed—see FIG. 10 which shows a screen-shot illustrating that imported data for route data collection sessions are ready to be analyzed in accordance with one or more embodiments of the present invention, which screen-shot may be fabricated utilizing any one of a number of methods that are well known to those of ordinary skill in the art.

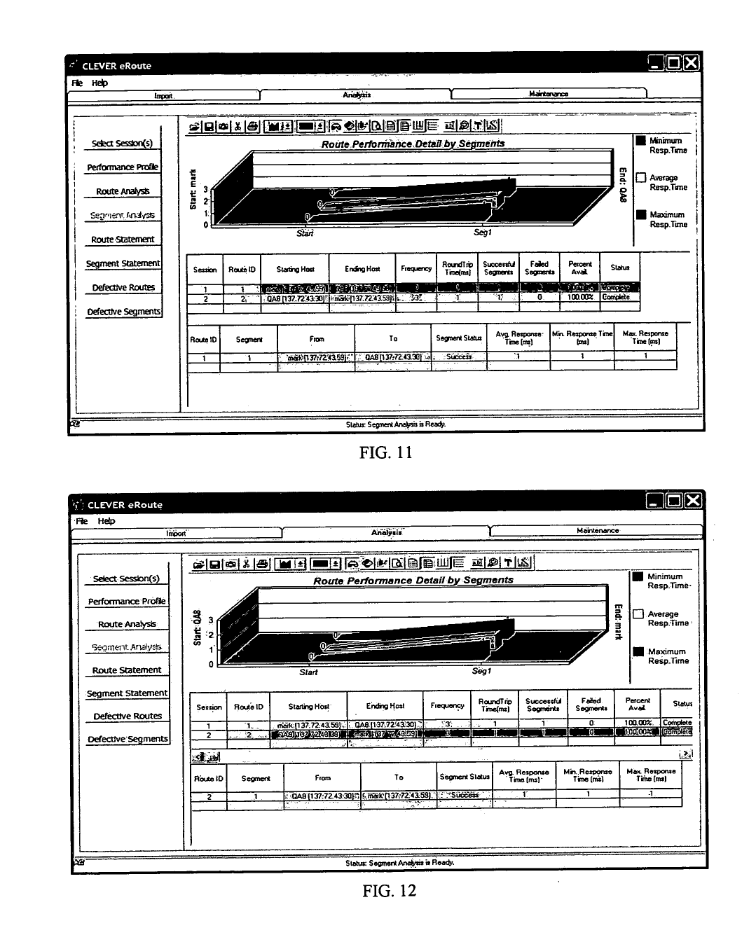

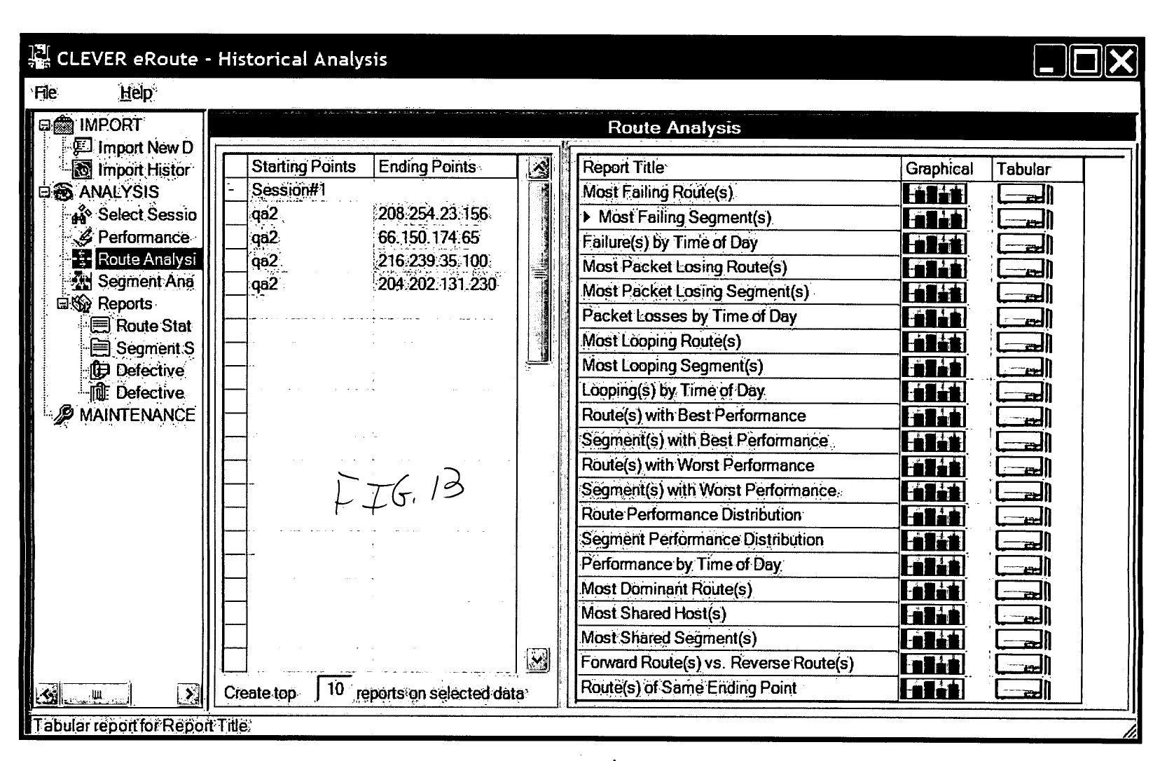

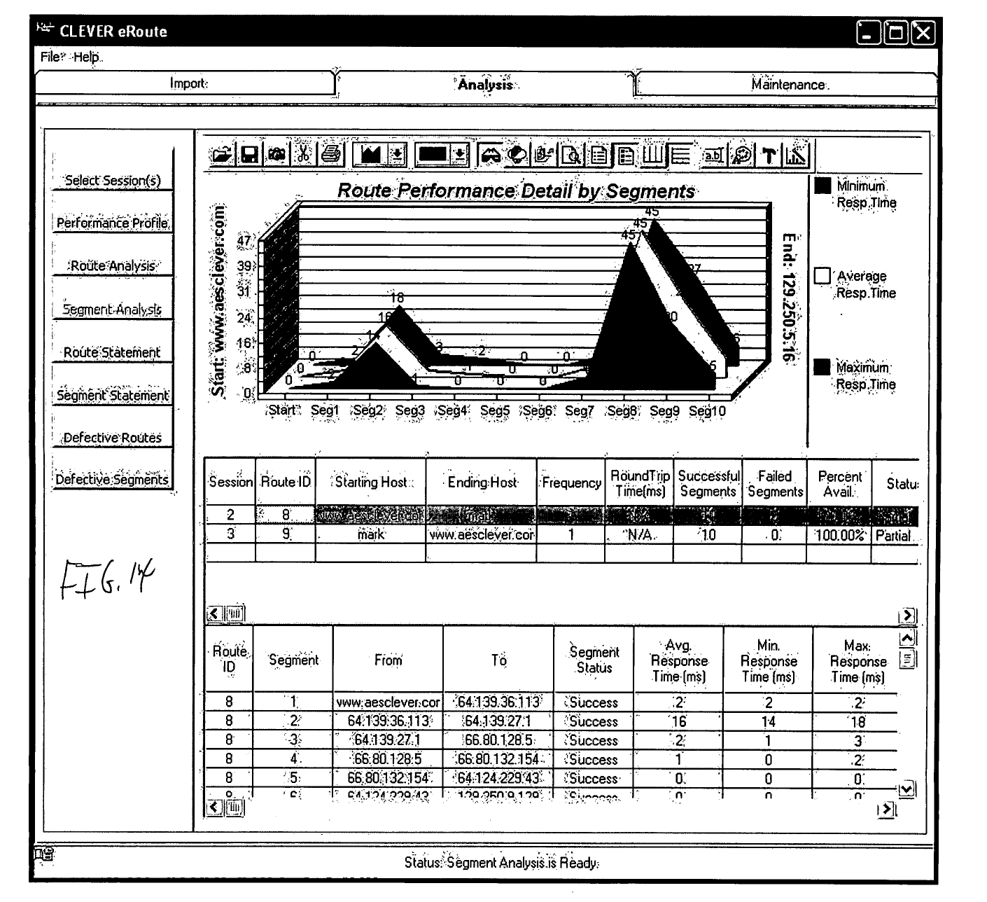

Analysis Module: after importing the contents of these files into a CLEVER eRoute® software application database, the results from the forward route are displayed in FIG. 11 (FIG. 11 shows a screen-shot providing an analysis of the forward route 137.72.43.59 to 137.72.43.30 consisting of one hop in accordance with one or more embodiments of the present invention, which screen-shot may be fabricated utilizing any one of a number of methods that are well known to those of ordinary skill in the art) and the results from the reverse route are displayed in FIG. 12 (FIG. 12 shows a screen-shot providing an analysis of the reverse route 137.72.43.30 to 137.72.43.59 consisting of one reverse hop in accordance with one or more embodiments of the present invention, which screen-shot may be fabricated utilizing any one of a number of methods that are well known to those of ordinary skill in the art). As one can readily appreciate from this: (a) both routes take the same path; (b) each route consists of one hop; and (c) the response-times are identical for both routes. Of course this is the simplest case where the two nodes are adjacent to one another within the same sub-network.

As was described above, forward route vs. reverse route analysis becomes important when opposite end-points cross inter-networks, and each network group is governed by a separate network administration. In such a case, the path traversed in the forward direction might look different than the path traversed in the reverse direction. This is so for one reason that paths connecting a node from one network to another node from another network are dynamically allocated. Figuring out the best, most cost effective route requires views from both directions.

The CLEVER eRoute® software application provides many different methods for analyzing route data collection. For example, a screen-shot of a Route Analysis indicating the various reports available. As one can readily appreciate, the Route Analysis screen-shot includes two tables. The first table lists starting and ending points for selected sessions(s), and the other table lists available Analysis Reports with a link to graphic and tabular report formats for each of them. In accordance with one or more embodiments of the present invention, available Analysis Reports include: (a) Most Failing Route(s): defined as unreachable routes by most occurrences. A route is considered failing only if there is no alternate route available and it never reaches its intended endpoint. (b) Most Failing Segment(s): defined as unreachable segments by most occurrences. A segment is considered “failing” only if there is no alternate segment available and it never reaches its intended endpoint. (c) Failure(s) by Time of Day: pinpoints unreachable routes and segments by time of day. (d) Most Packet-Losing Route(s): are those routes experiencing the highest frequency of packet loss. (e) Most Packet-Losing Segment(s): are those segments experiencing the highest frequency of packet loss. (f) Packet Losses by Time of Day: indicates the frequency of packet loss by time of day. (g) Most Looping Route(s): are defined as those routes experiencing the highest frequency of looping, which occurs when a Host is noted more than once in a route. (h) Most Looping Segment(s): are defined as those segments experiencing the highest frequency of looping, which occurs when a Host is noted more than once in a route. (i) Looping by Time of Day: indicates the frequency of looping by time of day. (j) Route(s) with Best Performance: indicates the route(s) having the shortest response time [response time is the time it takes to perform a TRACERT from the starting point to the ending point (in milliseconds)]. (k) Segment(s) with Best Performance: indicates the segment(s) having the shortest response time [response time is the time it took using the TRACERT command to propagate a fixed-size packet from the starting point to the identified segment (in milliseconds)]. (l) Route(s) with Worst Performance: indicates the route(s) having the longest response time [response time is the time it took (in milliseconds) using the TRACERT command to propagate a fixed-size packet from the starting point to the intended ending point]. (m) Segment(s) with Worst Performance: indicates the segment(s) having the longest response time [response time is the time it took (in milliseconds) using the TRACERT command to propagate a fixed-size packet from the starting point to the identified segment]. (n) Route Performance Distribution: shows the distribution of Route Response Times by Date and Time for Routes. (o) Segment Performance Distribution: shows the distribution of Route Response Times by Date and Time for Segments. (p) Performance by Time of Day: shows whether there are any high or low points in response time that are correlated with time of day [The Minimum Response Time in milliseconds for the segment, based upon the total number of scans done for the route; Average Response Time in milliseconds for that segment where it is calculated by averaging the total response times of all hops preceding the current one and subtracting that from the current hop's response time; Maximum Response Time in milliseconds for the segment, based upon the total number of scans done for the route]. (q) Most Dominant Route(s): shows which route is the most frequently used among all the routes used between the starting and ending points for a particular session(s). (r) Most Shared Host(s): shows the hosts most shared between the starting and ending points for the selected session(s). (s) Most Shared Segment(s): shows the segments most shared between the starting and ending points for the selected session(s). (t) Segment Analysis: provides scan results for segment analysis in the Route Performance Detail by Segments report. (u) Route Statement: a Data Summary Report by Routes. (v) Segment Statement: a Data Summary Report by Segments. (w) Defective Routes: a Summary Report for Defective Routes. (x) Defective Segments: a Summary Report for Defective Segments is displayed.

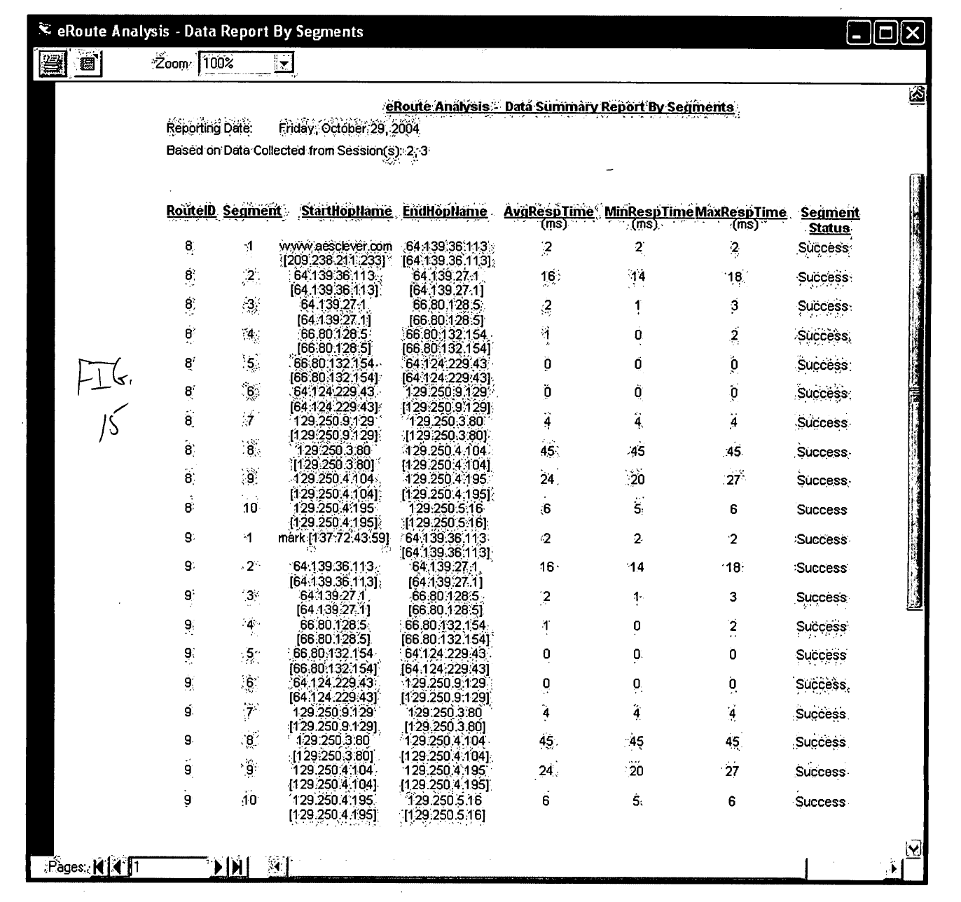

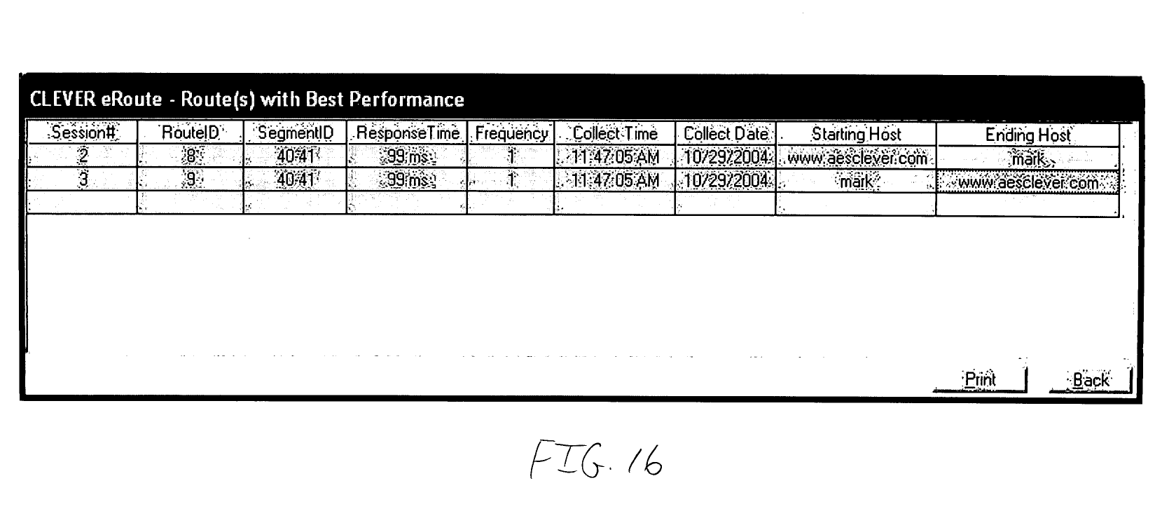

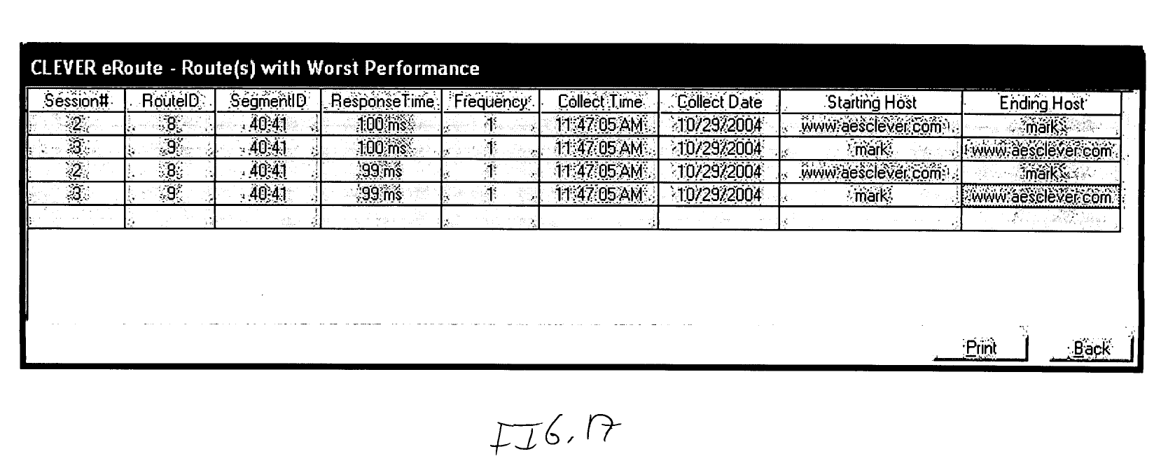

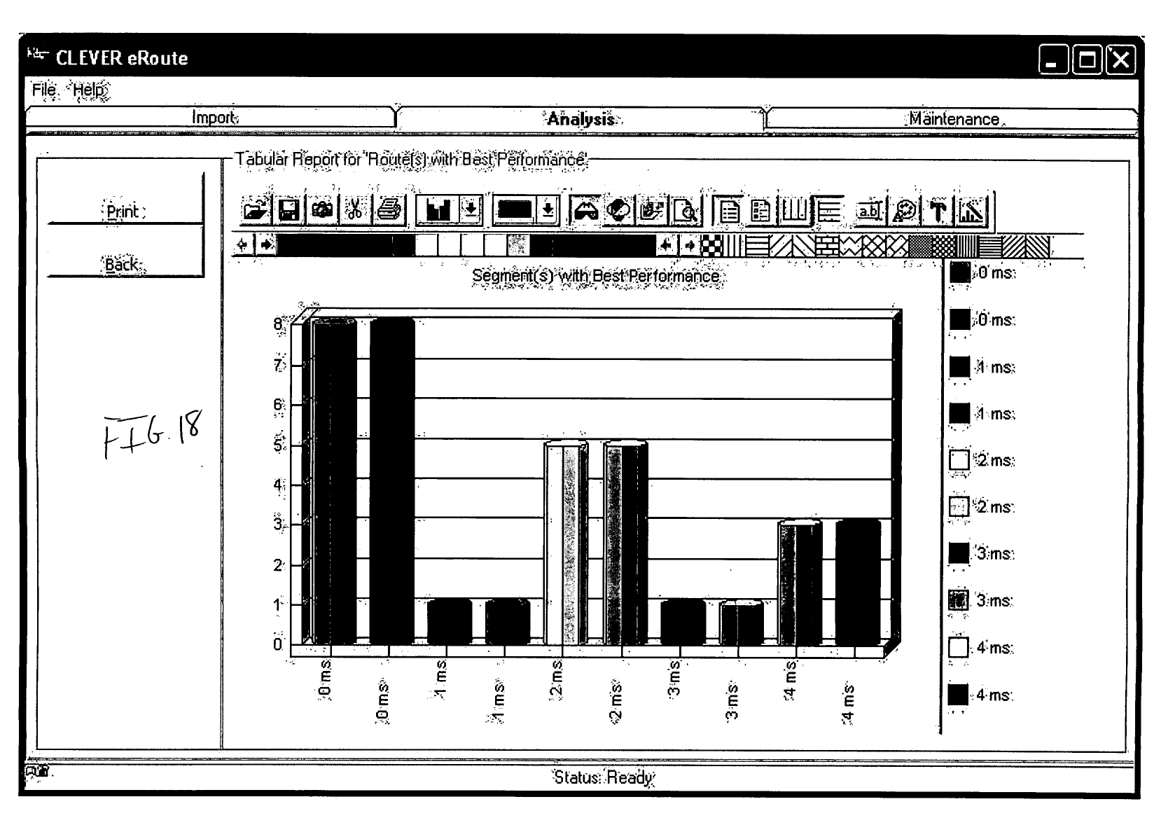

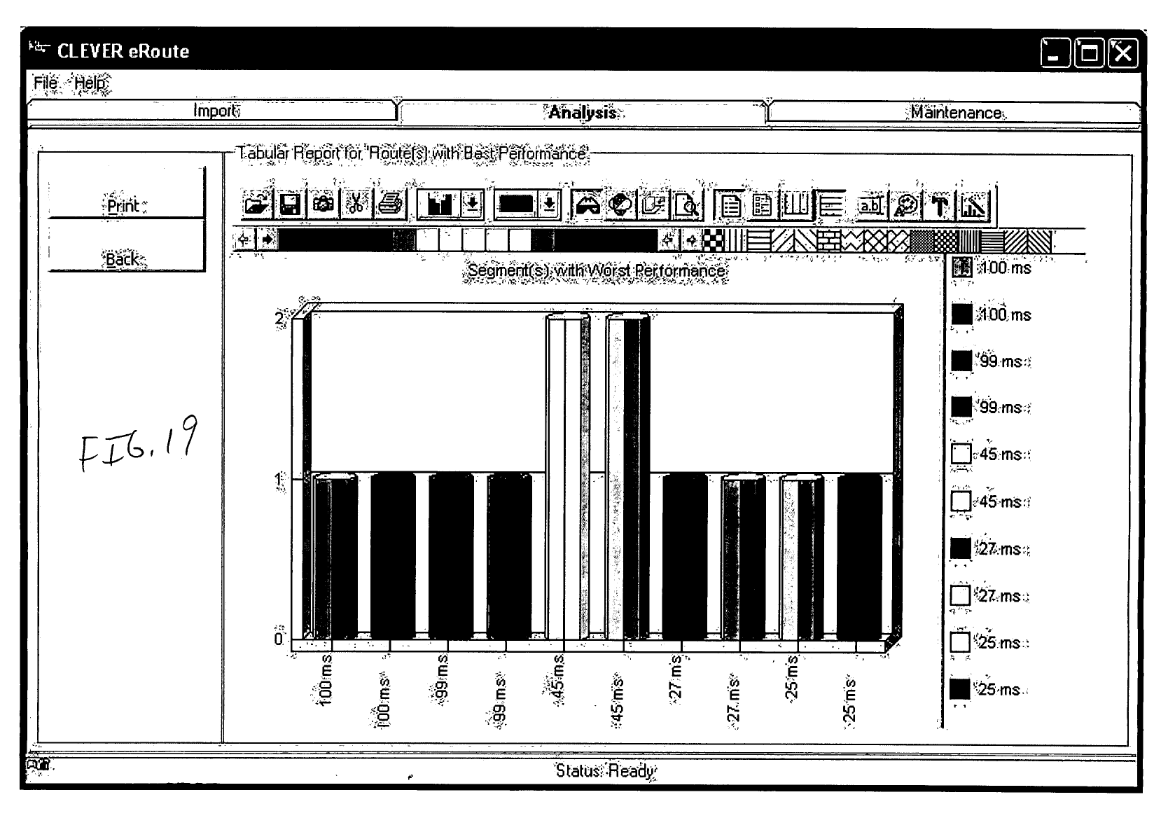

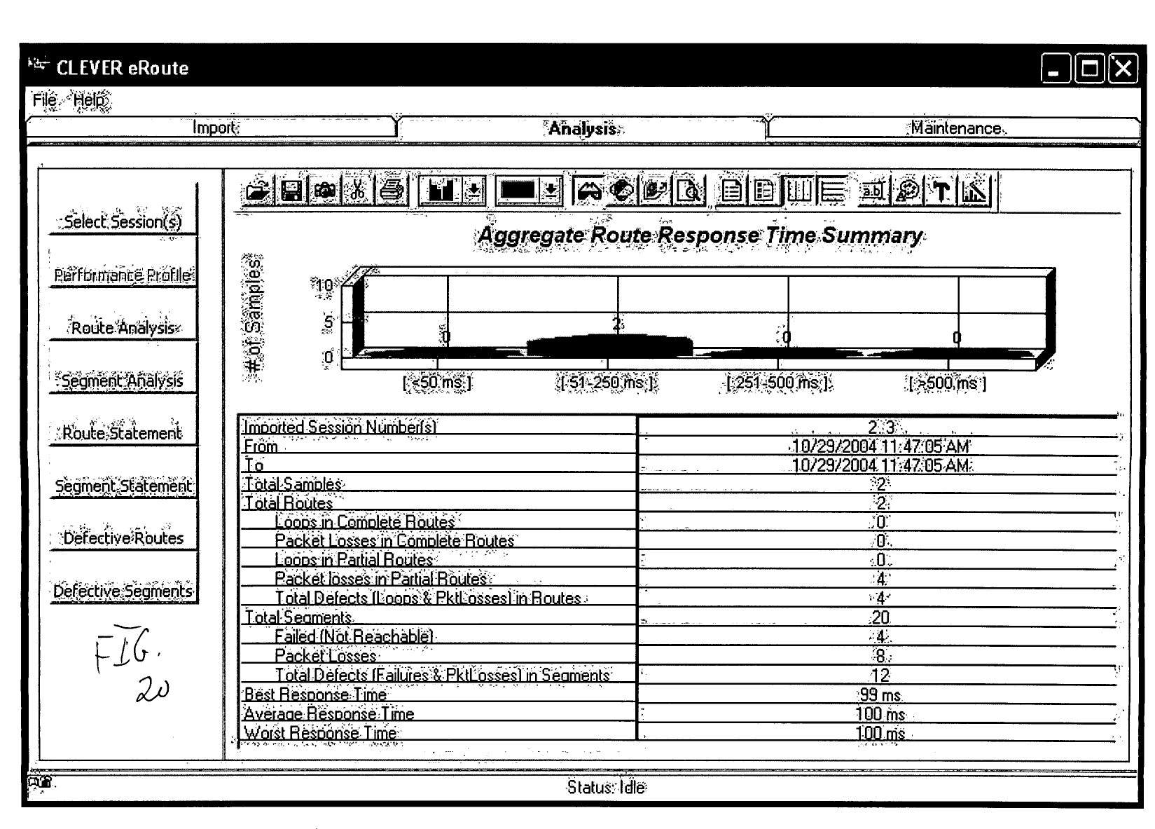

As one can readily appreciate, one can perform some or all of the above listed analyses for forward and reverse routes. As example, FIG. 14 shows a screen-shot of a Route Performance Detail by Segments report for forward and reverse routes; FIG. 15 shows a screen-shot of a “Data Summary Report by Segments” report for forward and reverse routes; FIG. 16 shows a screen-shot of a “Route(s) with Best Performance” report for forward and reverse routes; FIG. 17 shows a screen-shot of a “Route(s) with Worst Performance” report for forward and reverse routes; FIG. 18 shows a screen-shot of a “Segment(s) with Best Performance” report for forward and reverse routes; FIG. 19 shows a screen-shot of a “Segment(s) with Worst Performance” report for forward and reverse routes; and FIG. 20 shows a screen-shot of an “Aggregate Route Response Time Summary” report for forward and reverse routes. In fact, as shown in FIG. 13, one Report Title, “Forward Route(s) vs. Reverse Routes” provides a report where the data collected at the Master module is searched for “Forward and Reverse” routes (i.e., routes having matching starting and end points), and the analyses are provided together automatically.

Although various embodiments that incorporate the teachings of the present invention have been shown and described in detail herein, those skilled in the art can readily devise many other varied embodiments that still incorporate these teachings. For example, although the discussion of embodiments related mainly to TCP/IP networks, it should be understood that further embodiments of the present invention are not limited to such networks, and may relate to networks of all kinds.

What is claimed is:

1. A method for collecting route data for forward and reverse routes that comprises:
scheduling route data collection for a forward route; and
scheduling route data collection for a reverse route;
wherein the scheduling for the forward and reverse routes provides for data collection to be initiated at about the same time.

2. The method of claim 1 which further comprises:
collecting the route data for the forward route utilizing collector agents; and
collecting the route data for the reverse route utilizing collector agents.

3. The method of claim 2 wherein the collector agents are managed by a master module by way of a client-server relationship.

4. The method of claim 3 wherein the collector agents operate in an agent-server mode.

5. The method of claim 3 wherein the step of collecting further comprises the collector agents sending the route data to the master module.

6. The method of claim 5 wherein the route data is analyzed at the master module.

7. The method of claim 2 wherein the step of collecting comprises a collector agent: (a) transmitting packets to each node along a path that constitutes a route, wherein the route is a path between a starting point and an ending point that consists of one or more segments, and wherein a segment is a path between two network nodes; and (b) collecting a response time for each packet.

8. The method of claim 7 wherein the step of obtaining data further comprises the collector agent transmitting the response times associated with each network node to the master module, which response times provide information on route performance.

9. The method of claim 6 wherein the master module analyzes the data by organizing and presenting it to a user in various formats.

10. The method of claim 6 wherein data for forward and reverse routes between user-determined end points are collected at pre-defined intervals to provide an historical data base of route performance and failure traffic patterns.

11. The method of claim 2 wherein the forward and reverse routes are TCP/IP network routes.

12. The method of claim 2 which further comprises analyzing the route data to determine congested routes, defective routes, and usage patterns.

13. The method of claim 2 which further comprises analyzing the data to monitor performance and troubleshoot problems.

14. A method for collecting route data for forward and reverse routes that comprises:
a master module initiating route data collection by a collector agent for a forward route; and
the master module initiating route data collection by a collector agent for a reverse route; and
the collector agents sending the route data to the master module.

15. The method of claim 9 where the analysis provides summary reports which identify all routes and segments and aggregate response times and/or defects.

16. The method of claim 9 wherein data is gathered together, analyzed and formatted into graphical and/or tabular reports.
